(19) United States
(12) Patent Application Publication
(10) Pub. No.: US 2024/0311751 A1
(43) Pub. Date: Sep. 19, 2024

(54) SYSTEM AND METHOD FOR BUNDLING DELIVERIES AND MATCHING AUTHENTICATED DRIVERS TO THE BUNDLED DELIVERIES

(71) Applicant: Roadie, Inc., Suwanee, GA (US)

(72) Inventors: James Delmerico, Suwanee, GA (US); Jay Modh, Suwanee, GA (US)

(21) Appl. No.: 18/599,493

(22) Filed: Mar. 8, 2024

Related U.S. Application Data
(60) Provisional application No. 63/490,391, filed on Mar. 15, 2023.

(51) Int. Cl. G06Q 10/0835; G06F 21/32

(52) U.S. Cl. CPC G06Q 10/08355; G06F 21/32

(57) ABSTRACT

This disclosure relates to systems and methods for efficient delivery of a package as part of a system of sorting and delivery of many packages. Bins at a depot are assigned a delivery route. The depot receives packages for trans-shipment. The depot sorts the packages into a bin associated with a delivery route associated with that package. The system automatically notifies the depot when a driver is approaching to coordinate having the bin ready for pick-up at the appropriate time. The driver's identity may be authenticated as part of the process.

### BACKGROUND OF THE INVENTION

The present invention relates to bundling deliveries and matching authenticated drivers at a depot.

Depots are increasingly important not just for trans-shipment of goods at the wholesale level, but even for retail deliveries. As part of the system of shipping goods from a supplier to a purchaser, many items are shipped to a depot, where they are sorted into delivery routes and then sent on to be delivered to their final destination. The assignment of deliveries and the sorting of the goods to be delivered is ripe for implementation of new efficiencies.

The depot owner and operator may not have the ability to interface with delivery drivers and wish to maintain security around their premises.

Accordingly, a need arises for methods and system that provide an efficient and secure method of assigning drivers to routes and distributing items for delivery from a depot.

### SUMMARY OF THE INVENTION

Aspects of the disclosure relate to systems and methods for organizing items and communicating amongst participants to effect an efficient delivery of a package. The system may comprise a server, a personal electronic device associated with a delivery driver, and an electronic device associated with a depot. The system may have all these elements communicating to perform a method. The method may comprise receiving at the depot electronic device from the server a request for sorting of the plurality of items. The method may further comprise determining, at the server, the appropriate route for a subset of the plurality of the items to be delivered and also sending, from the server to the depot electronic device and to the delivery driver electronic device, information about a delivery route assigned to the subset of the plurality of items to be delivered. The depot may place the subset of items into a bin. The bin may be associated with a delivery route. The method may authenticate the delivery driver once the delivery driver has arrived at a designated location proximate the depot. The delivery driver's device may scan the subset of items as the subset of items is transferred from the depot to a vehicle associated with the delivery driver. The method may further communicate to the server that the items have been transferred from the depot to the vehicle of the delivery driver.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and the invention may admit to other equally effective embodiments.

FIG. 1 illustrates what happens to a package after it has arrived at a depot.

FIG. 2 illustrates how the method functions from the perspective of a delivery driver.

FIG. 2B illustrates how a direct driver dispatch may work.

FIG. 3 illustrates a flow diagram of the method.

FIG. 4 illustrates a flow diagram of the method.

FIG. 5 illustrates another flow diagram of the method continued from FIG. 4.

FIG. 6 illustrates a set of bins.

FIG. 7 illustrates an exemplary screen showing consolidated items.

FIG. 8 illustrates an exemplary summary display of drivers.

FIG. 9 illustrates a depot computing device.

FIG. 10 illustrates a driver computing device.

FIG. 11 illustrates a server.

FIG. 12 illustrates the interactions amongst the devices.

Other features of the present embodiments will be apparent from the Detailed Description that follows.

### DETAILED DESCRIPTION

In the following detailed description of the preferred embodiments, reference is made to the accompanying drawings, which form a part hereof, and within which are shown by way of illustration specific embodiments by which the invention may be practiced. It is to be understood that other embodiments may be utilized and structural changes may be made without departing from the scope of the invention. Electrical, mechanical, logical, and structural changes may be made to the embodiments without departing from the spirit and scope of the present teachings. The following detailed description is therefore not to be taken in a limiting sense, and the scope of the present disclosure is defined by the appended claims and their equivalents.

The present disclosure relates to bundling of delivery items for more efficient and secure routing of item delivery.

For a delivery system to be efficient and secure requires multiple steps at multiple points throughout the process. A customer may create an order for delivery of an item from a first location to a second location. For a delivery service, it may make sense to gather as many items as possible at a first location (e.g. a depot) to aid in further shipping of all the items through consolidation of delivery routes. For instance, in cross-country shipment, it makes business sense to first ship all items on overnight delivery to a first airport, then at this location consolidate all the items being shipped to the same destination airport, and then to ship the items. On a smaller scale, such as a metropolitan area, a similar consolidation may be the most efficient solution to this shipping problem. In this instance, a customer may create an order for delivery of an item. The customer may initiate a delivery request on a personal electronic device. The item for delivery (e.g. a package, a flower bouquet, etc.) may be picked up and shipped first to a depot. In an alternative embodiment, the items being shipped may be assembled at a particular location (e.g. flower shop), which itself becomes a depot for this method and system. At the depot, the item may be received, or assembled or manufactured. Prior to sorting at the depot, the requested shipment may be entered in a routing algorithm which creates consolidations of delivery routes. This routing algorithm may reside and run on a server. The algorithm may notify the depot of the list the items to be consolidated and how the items are to be sorted into bins for consolidated delivery routes. For instance, the depot may receive a list of items with a set of pre-labelled bins (e.g. JAX-01, JAX-02, JAX-03, etc.). Each item may be associated with one bin. The notification may take place via, for instance, a mobile app on a depot worker's phone, or to a fully automated depot's communications section.

The assignment of items or packages to delivery routes, and thus to a bin associated with a particular route, may be separate from the assignment of delivery drivers to routes. For example, if a first driver is in a car accident on the way to the depot, then a second driver may be assigned to deliver the items on the first driver's route. This latter assignment can occur separately from the assignment of delivery items to bins at the depot. Thus the depot system may only need to know the information about how to sort the items by delivery route. The driver and the depot may be updated as needed when the time arrives to pick up the items.

In an embodiment, a driver may be dispatched directly to a depot for delivery of a certain item or items. In another embodiment, the driver may arrive at the depot, check-in, and then receive their delivery assignment(s). In an embodiment, a third party system may make consolidated item delivery routes available for drivers to bid on. Such a system may automatically match the bids/offers made by delivery drivers for the routes. The system may also include incorporating new routes or alternative routes through an iterative process. An example of a sub-system which matches routes and delivery offers is provided in U.S. Pat. No. 11,436,556 “Method and system for delivery assignment and routing” the entirety of which is incorporated herein by reference. At any time once the items have been assigned to be delivered, the items may be assigned or re-assigned to a delivery route. The route may comprise a single item for delivery to a single address, multiple items for delivery to a single address, or multiple items for delivery to multiple addresses. Once the item has been assigned a route, the depot may be notified that the item is ready for sorting along with the appropriate route assigned to that item. The depot may then proceed to sort the items into bins, each bin being associated with a particular route. The goal is to have the items for delivery sorted into bins just prior to the arrival of the delivery driver at the depot for pickup.

The depot notification may also comprise additional information such as the items for the delivery, the size of the items, the initial route (e.g. by number or name or list of streets) or routes, the driver's name, the driver's mobile phone number, the driver's vehicle (e.g. make, model, year, license plate, VIN, etc), a driver's location, a designated pick-up location, or other information associated with the driver, the driver's vehicle, the route, or the items for delivery. The delivery driver may also be sent a notification of the route which may comprise the same information as the warehouse notification or the driver notification may comprise additional information relevant for the delivery (e.g. weather forecast, construction warnings, oversized items, etc.) The information received by the driver may be the same as the information sent to the depot, or the information may be different. In an embodiment, the driver may also be assigned a particular location (e.g. a particular parking space) where they are required to park their vehicle to receive the items for delivery. In an alternative embodiment, the driver may park in any open parking space and inform the system of their parking location. When the driver's vehicle is approaching the depot, the depot may be notified that the driver is getting close. Such a notification may be made automatic through the use of, for example, a geo-location system (e.g. GPS or other satellite navigation system) located, for instance, on the delivery driver's mobile phone or other personal device. When the driver's vehicle nears the depot, the depot facility may then move the bin containing the items to be delivered to a location close to the designated vehicle location to make the transfer more efficient. When the driver's vehicle arrives, the depot may be automatically notified that the driver has arrived in the selected location and may also authenticate the driver's identity. Authentication schemes may include two-factor authentication, biometric authentication, geolocation information, passwords, passcodes, or other methods as deemed appropriate. An example authentication may comprise requesting the driver to identify the route number the driver was assigned to deliver or requesting the driver to confirm whether a randomly chosen item barcode is part of the delivery request. Another authentication example may comprise requesting the driver to share a special passcode sent by a separate system (e.g. email, phone call, or text message) or requesting the driver to share other information associated with the assigned delivery route. The passcode may expire after a brief time delimited or the passcode may be a single-time use passcode. Once the driver's identity has been authenticated and the driver arrives at the designated trans-shipment location, the bin containing the items may already be in close proximity.

The delivery driver then receives the items to be delivered from the bin associated with a particular route. For some special cases, such as a driver having a larger than anticipated vehicle, a delivery driver may receive more than one bin's worth of items. As noted above, the assignment of routes for the delivery drivers may occur separately from the assignment of routes for the sorting of items into route-associated bins at the depot.

In the depot, as every package is received and sorted, a depot facility, or a depot worker, may scan the incoming item which contains an identifying marker of some kind (e.g. barcode, QR code, rf ID, or the like). This receipt and identification of each item may proceed with a dedicated scanner or through a personal electronic device such as a mobile phone using a sensor like a camera (e.g. barcode scanner, rf ID scanner, mobile phone equipped with near field scanner, or mobile phone with camera and QR code software). The item is identified as belonging to a delivery service and the depot is notified which route the item has been assigned to. The depot then sorts each item into the bin associated with that route. As the bins typically also have some marker, as the items are sorted, the bins may also be scanned and identified, so that the electronic devices maintain a proper inventory of which items are located in which bins. If no route has been identified with the route assigned to the item, then a new, empty bin may be taken and the item placed in that bin, and that bin then becomes associated with the route associated with the that item. The end result is that the items associated with the delivery service are sorted not just into a single bin associated with the delivery service, but into bins wherein each bin is associated with a particular pre-assigned route.

As noted elsewhere in this disclosure, when the delivery driver assigned to a particular route approaches the depot, then the depot may automatically receive a notification that the delivery driver is nearing the depot and may also the specific pick-up location for that driver. When the bin with all the items for a specific route is picked up by the delivery driver, the driver will then re-scan all the items during the transfer to confirm that they have been picked-up from the depot. The driver then may follow the determined route and make the deliveries.

The system described above may work with a fully automated depot, but may also work with a partially automated depot. For example, while human delivery drivers may submit bids on delivery groups of packages and then be provided with the packages at an automated depot, they could also receive the items from a human worker at the depot. This method may connect the delivery driver with the distribution center.

One example of this method may use an application programming interface (API) which receives the information about the various items being shipped. These items would then be picked up, shipped to the depot and, once the route has been assigned to an item, placed in a bin. A sub-system may help the depot worker (or the depot facility for a fully automated depot) identify and sort the packages to be delivered.

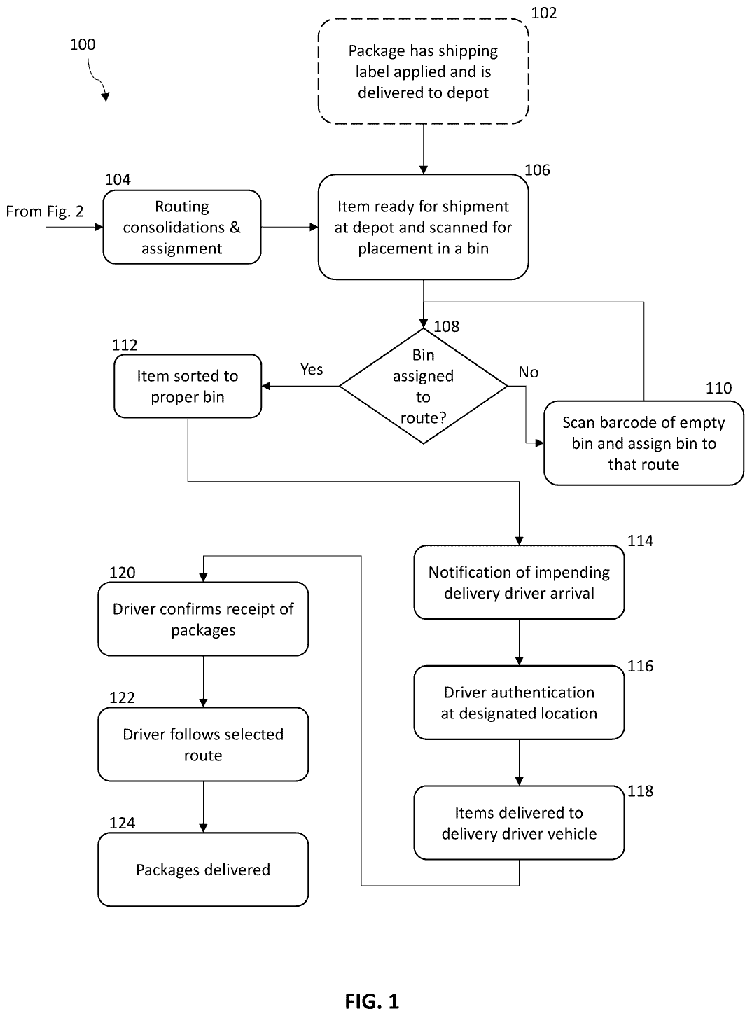

FIG. 1 illustrates an embodiment of the method. The system 100 starts with an item for shipment. The item or packages has already had a shipping label applied and has been delivered to the depot at step 102. The dashed line indicates that these steps have already occurred. In an embodiment the item may be received by the depot and ready for shipment at 106. In an alternative embodiment, the item may be manufactured or assembled at the depot and is readied for shipment at 106, including being scanned for placement in a bin. In an embodiment a consolidation and assignment sub-system 104 may have already performed a consolidation and assignment of the routes for these packages prior to the items being sorted at the depot. In another embodiment, the drivers may receive a dispatch with a specific item request for delivery. The items ready for shipment are scanned for placement in the appropriate bin 106. When an item is scanned at 106, a route is associated with that item. At step 108, a bin may be scanned. If the scanned bin is empty and not yet assigned to a route, then at 110 the empty bin is assigned to a route. That bin may be scanned by, for example, a barcode scanner, and then a route assigned to that bin. Once a bin has been assigned a route, then at the evaluation step 108, if the item belongs to that route, the item is sorted to that bin at 112. When a delivery driver approaches the depot at 114, the depot may receive a notification that a delivery driver is expected within a certain timeframe. The notification may contain other information relevant to the system. In an embodiment, the driver's identity may be authenticated and a designated location may be assigned to the driver's vehicle at step 116. In an embodiment, the driver's identity may be authenticated and the driver may park in a location and the system may communicate the location to the depot at step 116. At step 118, the packages or items may be delivered to the driver's vehicle. At step 120, the driver may confirm receipt of the packages. This confirmation may occur by having the driver scan a barcode for each package, as the driver takes receipt of the package. At step 122, the driver follows the selected route and at step 124, the packages are delivered.

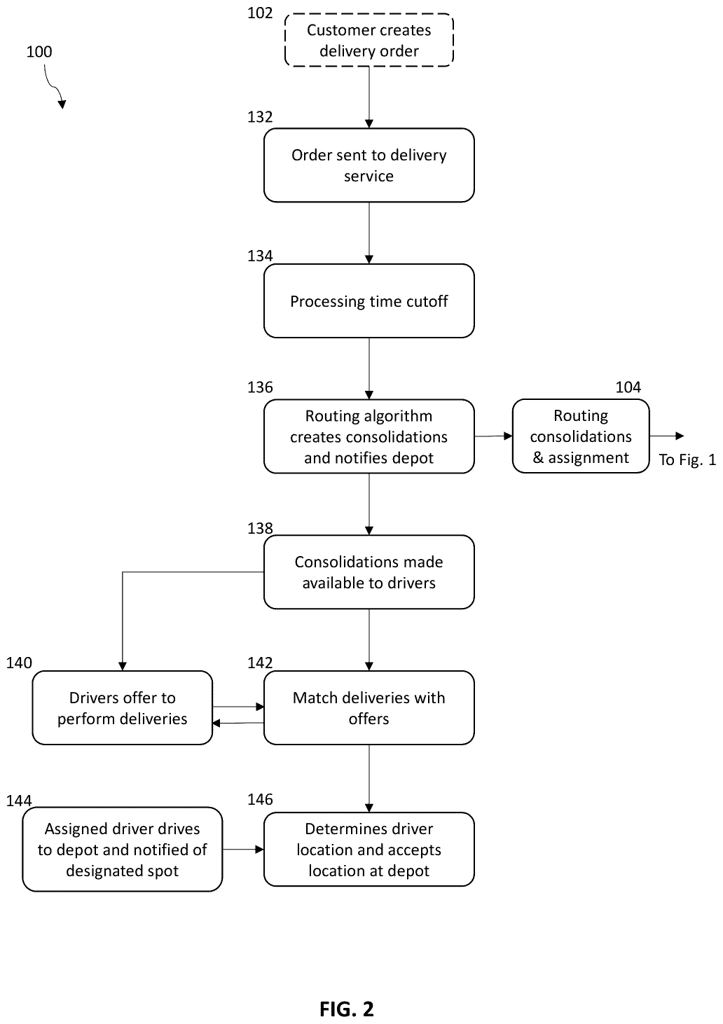

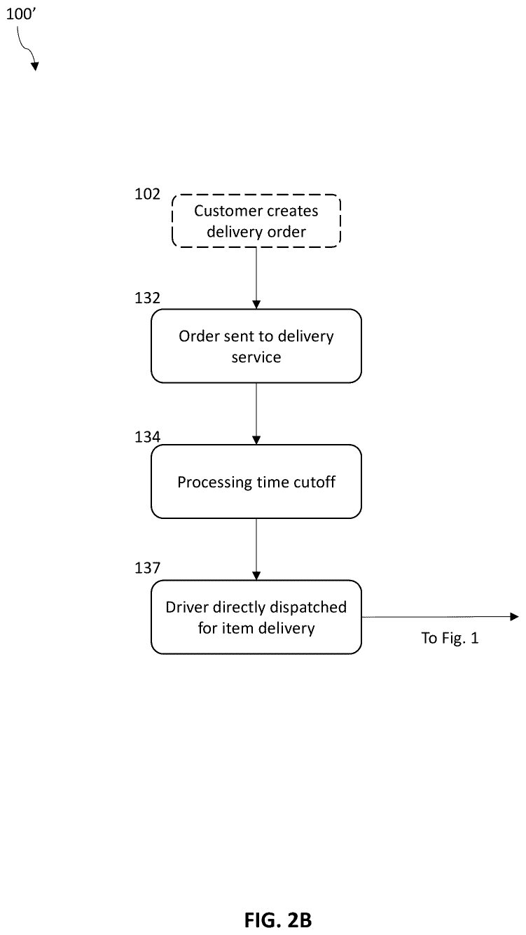

FIG. 2 illustrates another aspect of the method and system 100. As noted above a customer has already created a delivery order at 102, including applying a shipping label to the item or to the package. The delivery order may be sent to a delivery service at 132. A depot may have a cutoff time for receipt of delivery orders 134, after which the orders are processed in the following pickup interval. The pickup interval may be a whole day or a half day (e.g. morning or afternoon) or some other time. At step 136, the routing algorithm may create consolidations of delivery routes and may notify the depot at step 104 (as in FIG. 1). The list of initial routes sent to the depot at step 104 need not be the same as the list of routes which eventually are associated with the drivers. At step 138, the consolidations of routes of deliverable items may be made available to drivers for bidding. The drivers may make bids to perform deliveries at 140. At 142, the delivery drivers' offers may be matched with items for delivery. These driver assignments may consolidate the delivery of more than one item to make the deliveries more efficient. At 144, the assigned driver may receive notification of the depot, the assigned route, the items, and the designated location (e.g. parking spot) for the driver's vehicle. At step 146, the driver's location may be determined, that location's proximity to the depot may be calculated, an estimate of the time for the driver to arrive at the depot may be calculated, the designated location may be accepted, and the depot may be notified of the impending arrival. In an alternative embodiment, a driver may be dispatched to the depot for a specific delivery in which case the routing algorithm and the matching process may be altered accordingly.

FIG. 2B illustrates another embodiment of this system or method. In an embodiment, the routing assignment portion illustrated in FIG. 2 is replaced with an alternative delivery assignment portion 100′. As before, the customer creates a delivery order at step 102. At step 132, the order is sent to a delivery service and at step 134, there may be a processing time cutoff, after which further delivery requests may be filled the following pickup period (e.g., the following day or the afternoon, if there are two pickups per day and the morning pickup deadline has passed). In this embodiment, a driver is directly dispatched to deliver and item at step 137. This information is sent to the system at step 106, when the item is ready for shipment at the depot.

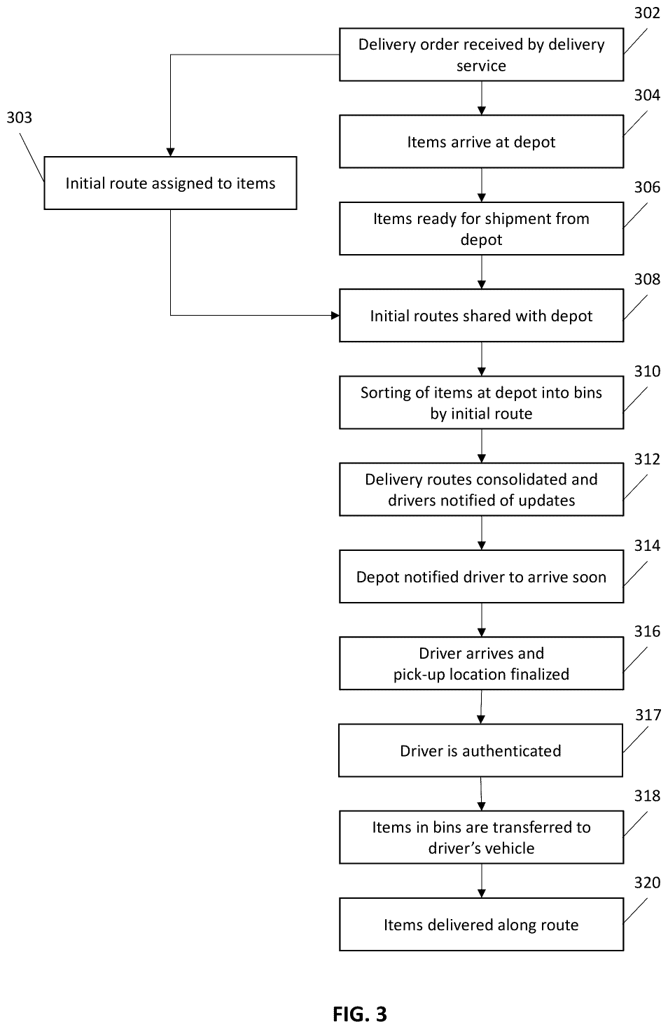

FIG. 3 illustrates a block diagram of an embodiment of the method or system. A delivery order may received at 302. Once the delivery order is received by the delivery service, at step 303, an initial route may be assigned to that item. In an embodiment, at step 304, the items or packages may arrive at a depot. In an embodiment, at step 306, the items may be received by the depot. In an embodiment, the items may be manufactured or assembled at the depot, so that steps 302, 304, and 306 may be combined into a single step of items ready for shipment from depot. (In an example, a set of flower bouquets may be assembled at a flower shop. When the bouquets are finalized, they are ready for pick-up from a flower shop without being delivered to the shop acting as a depot.) At step 308, the initial routes assigned to each item may be shared with the depot. At step 310, the items may be sorted at the depot into bins and each bin may be associated with an initial route. At step 312, the delivery routes may be consolidated and the drivers may bid on the chance to deliver the items. This sub-system may eventually assign to each item a driver and may also consolidate the initial routes assigned to the items to be delivered. At step 314, the depot may be notified that a driver will be arriving soon to pick up items for delivery. In an embodiment, at step 316, the driver may arrive, and may be notified of the designated pick-up location. In an alternative embodiment, at step 316, the driver may arrive and park their vehicle, and the depot may be notified of the driver's parking location. At step 317, the driver's identity may be authenticated. The authentication step 317 may also occur before the driver arrives at the depot. The authentication step 317 may occur prior to the driver parking their vehicle and the pick-up location (e.g. the driver's parking space) being finalized. At step 318, the appropriate items may be transferred to the delivery driver's vehicle. At step 320, the items are delivered along that route. If two or more initially assigned routes need to be consolidated, then that may occur at step 312, and the driver and the depot may be notified of the updated list of items to be transferred to the driver's vehicle.

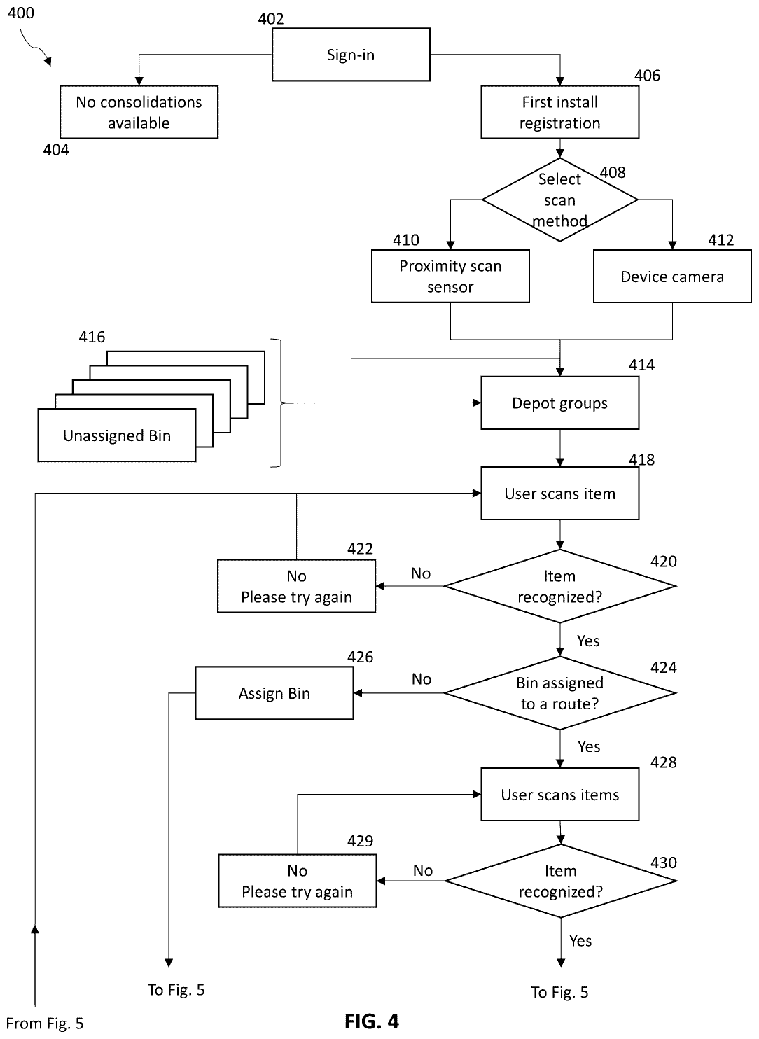

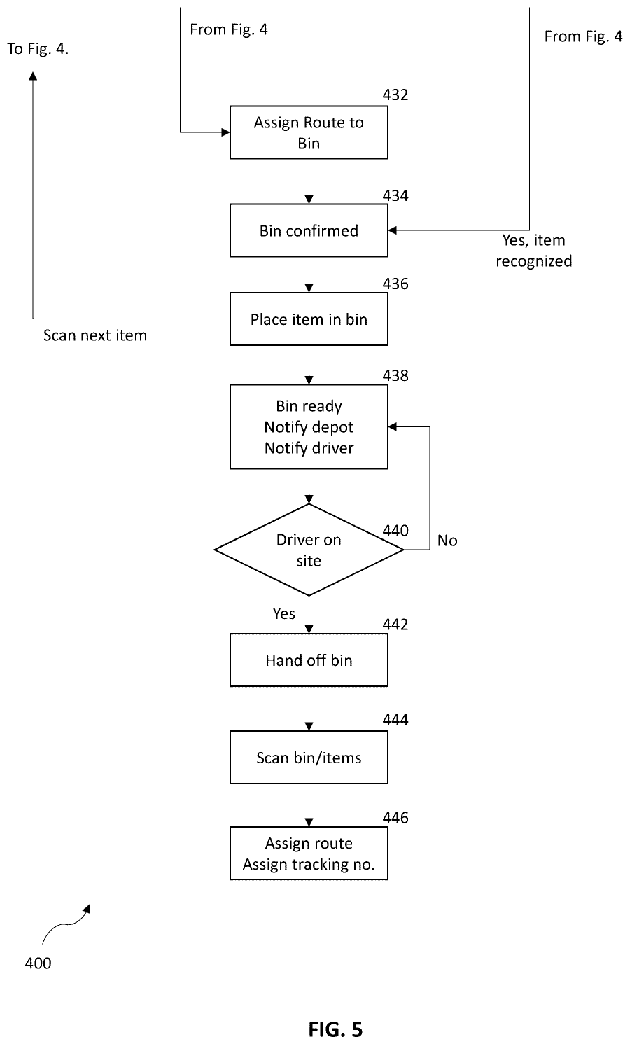

FIGS. 4 and 5 illustrate an example of the system in operation. The system 400 may start with a depot worker signing in to the system at 402. If no initial routes are available to enable sorting items into bins, then the depot worker may be notified at 404 to try again later. If this is the first time the depot worker has logged on, then at 406, the worker may be registered and asked to select a method for scanning items at 408. The worker may select, for example, a proximity scan sensor 410, a device camera 412. Although only two options are shown in the figure, there may be several options for detecting the information associated with each item. In the depot are bins 416 for consolidating items by initially assigned delivery route. These bins 416 may not yet be assigned to the initial delivery route. At step 414, the depot worker may select an item and a bin. At step 418, the worker may scan the item. At step 420, the item is either not recognized by the system 422 or is recognized by the system. If the item is not recognized, the worker may be requested to try again or to scan another item. After the item is recognized by the system, then at step 424, the question “Has the item's route been assigned to a bin?” is answered. If the answer is no, then a bin is assigned to the route for that item at steps 426 and 432. If a bin has already been assigned to that route, then the user again may scan the item at 428, and the item recognition step may occur. If the item is not recognized, the worker may be requested to try again at 429. If the item is recognized, then the bin may be confirmed at step 434 and the worker may place the item in the bin at step 436. The worker may then scan the next item and repeat the process from step 418 onwards until all the items have been sorted and placed in their assigned bins. At step 438, the depot may be notified that the bin is ready. This notification may also include notifying the driver that the items are ready for pick-up at a depot. At step 440, it may be evaluated whether the driver has arrived to the designated location at the depot. Once the driver has arrived, the bin with the items may be handed off to the driver at step 442. At step 444, the driver scans the items as the items are transferred to the driver's vehicle. Then the driver delivers the items along the assigned route at step 446. In an alternative embodiment, at step 444, the driver may scan the bin without scanning each individual item.

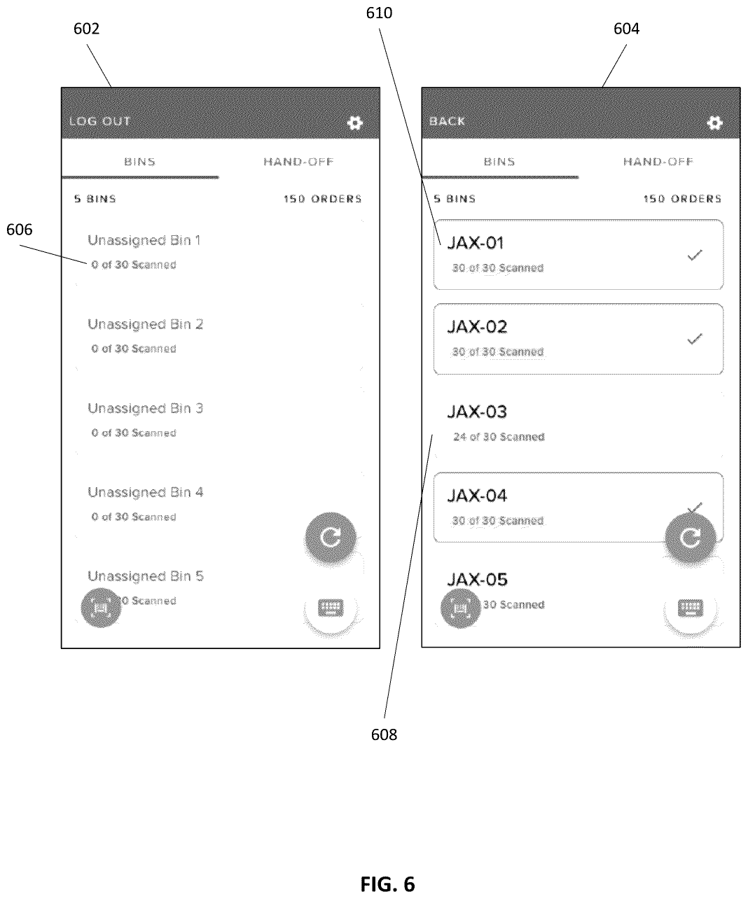

FIG. 6 illustrates some screens of, for instance, a depot worker's electronic device. Screen 602 shows a set of unassigned bins 606. Screen 604 shows a list of assigned bins, 608, 610. These assigned bins may be full 610 or they may not yet be full 608. The assigned bins 608, 610 may indicate, for instance, their destination city or other identifiers, and may also indicate the number of scanned items which are in the bin. In the example in the figure, each bin may carry only 30 items. The bin 608 labelled JAX-03 may have only 24 of the 30 items scanned and placed in it, so it is not yet full. The bin 601, labelled JAX-01, has 30 of 30 scanned items and so is already full. The display may include an indicator when the bin is considered full.

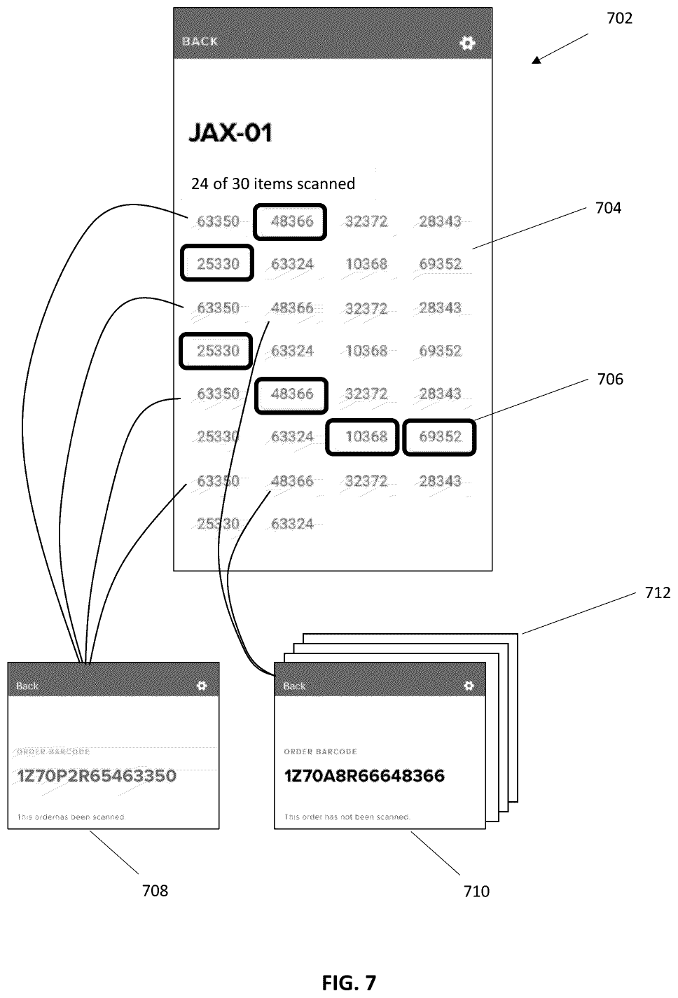

FIG. 7 illustrates an exemplary screen with details of an assigned, but not yet full bin 702. The bin 702 may contain a list of items, 704, 706, denoted by, for instance, the last five digits of a tracking code. In the example shown, the items without a border 704, have already been scanned. The items with a border 706 have not yet been scanned. Details of a tracking code are shown below at 708, 710, and others 712. Tracking code 708 has all of the items from the bin already scanned and in the bin. Tracking code 710 does not have all the items in the bin. Other tracking codes 712, may also be tracked, but are omitted for clarity.

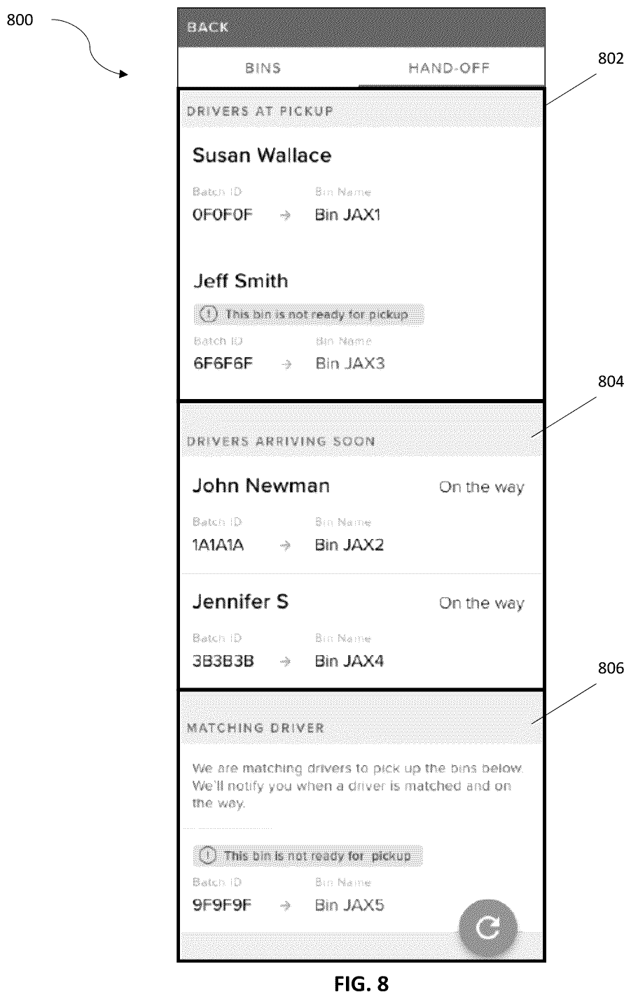

FIG. 8 illustrates a summary screen for hand-off 800 from the depot to the driver. An exemplary tab shows drivers already available and waiting at the designated pick-up location 802. In the example illustrated, a bin for one driver (“Jeff Smith”) is not yet ready for pick-up, but a bin for the other driver (“Susan Wallace”) is ready for pickup. A second tab 804 may display a list of drivers who may be arriving to the depot soon for pick-up. A third tab 806 may show alerts or bins or orders which have not yet matched to a driver, or other information.

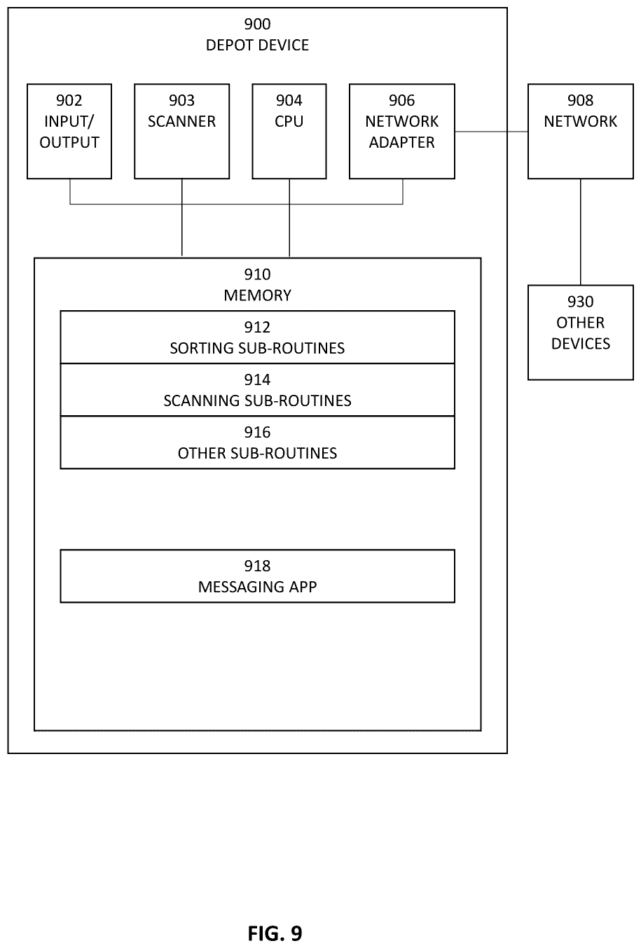

FIG. 9 illustrates an exemplary computing device for the depot. Such a device may comprise a central processing unit 904, various input and output devices 902, such as a mouse, a touch screen, audio output, etc., and a network adapter 906. The depot device may also have a sensor or scanner 903 to scan the packages as they are received and assigned to bins. The scanner 903 may also scan bins so that the items placed in the bin are known to be associated with the bin. In an embodiment, the scanner 903 may be a camera of a mobile phone. In an embodiment, the scanner 903 may be a radio frequency scanner. In an embodiment, the scanner 903 may be a device specific laser scanner or a barcode reader. The network adapter may enable the depot device to connect to a network 908, which may also connect to other devices 930 such as the server 1100 or the delivery driver device 1000. The device 900 may also comprise memory 910 which may have sub-routines for sorting 912, scanning 914 as well as other sub-routines 916. The device 900 may also have, stored in memory, a messaging application 918.

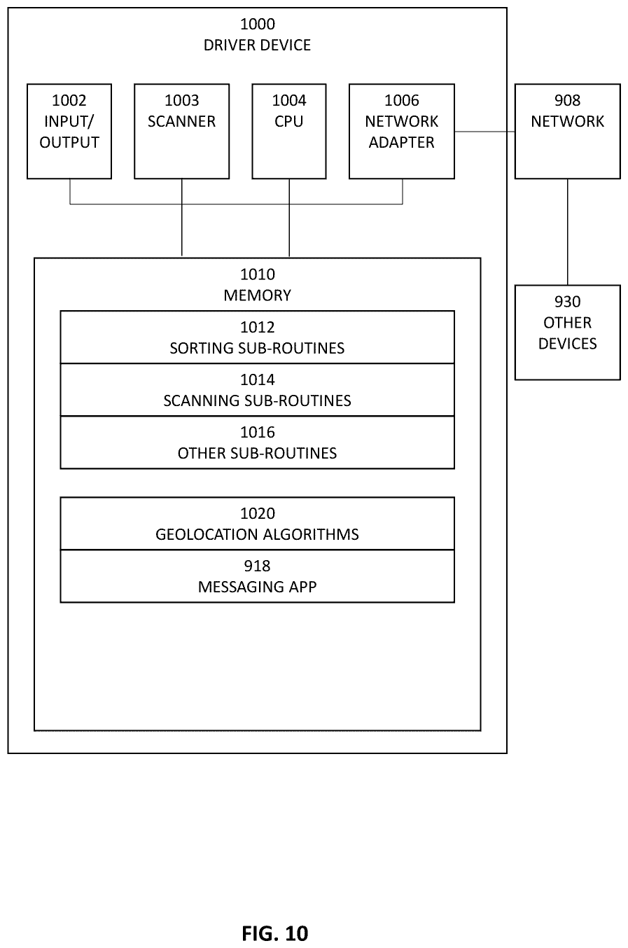

FIG. 10 illustrates an exemplary computing device for the delivery driver. Such a device may comprise a central processing unit 1004, various input and output devices 1002, such as a mouse, a touch screen, audio output, etc., and a network adapter 1006. The delivery driver device will also have a sensor or a scanner 1003 to scan the packages as they are received. In an embodiment, the scanner 1003 may be a camera of a mobile phone. In an embodiment, the scanner 1003 may be a radio frequency scanner. In an embodiment, the scanner 1003 may be a device specific laser scanner or a barcode reader. The network adapter may enable the delivery driver device to connect to a network 908, which may also connect to other devices 930 such as the server 1100 or the depot device 900. The device 1000 may also comprise memory 1010 which may have sub-routines routing 1012, for scanning 1014 as well as other sub-routines 1016. The device 1000 may also have, stored in memory 1010, a messaging application 918 and a geolocation algorithm 1020.

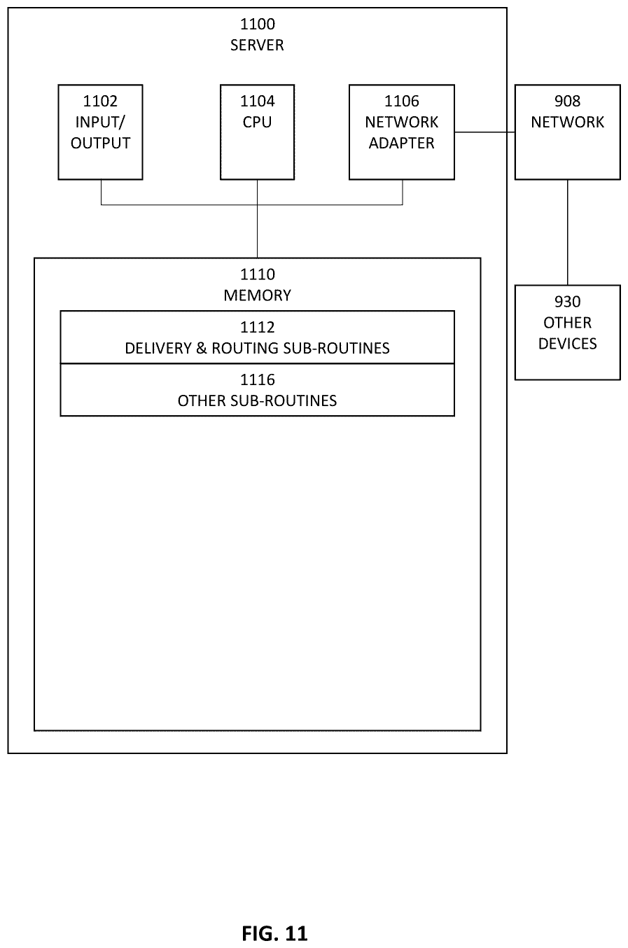

FIG. 11 illustrates an exemplary server. A server may comprise a central processing unit 1104, various input and output devices 1102, such as a mouse, a touch screen, audio output, etc., and a network adapter 1106. The network adapter may enable the server to connect to a network 908, which may also connect to other devices 930 such as the depot device 900 or the delivery driver device 1000. The server 1100 may also comprise memory 1110 which may have sub-routines for delivery and routing 1112, as well as other sub-routines 1116. The server may have other sub-routines or algorithms stored in memory as well, not shown in the figure.

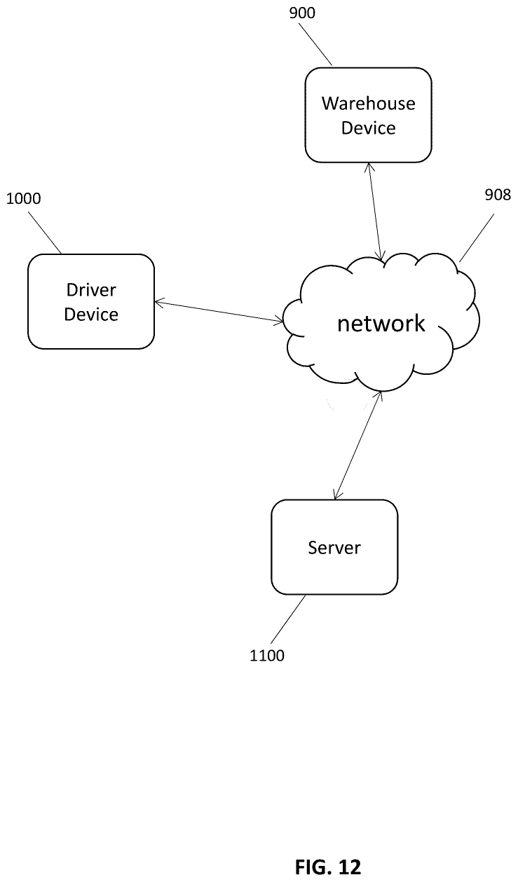

FIG. 12 illustrates the interaction amongst the computing devices: a server, a depot device, and a delivery driver's device. Each of these devices can be described by reference to FIGS. 9-11.

### Electronic Hardware

The present systems and methods may include implementation on a system or systems that provide multi-processor, multi-tasking, multi-process, and/or multi-thread computing, as well as implementation on systems that provide only single processor, single thread computing. Multi-processor computing involves performing computing using more than one processor. Multi-tasking computing involves performing computing using more than one operating system task. A task is an operating system concept that refers to the combination of a program being executed and bookkeeping information used by the operating system. Whenever a program is executed, the operating system creates a new task for it. The task is like an envelope for the program in that it identifies the program with a task number and attaches other bookkeeping information to it. Many operating systems, including Linux, UNIX®, OS/2®, and Windows®, are capable of running many tasks at the same time and are called multitasking operating systems. Multi-tasking is the ability of an operating system to execute more than one executable at the same time. Each executable is running in its own address space, meaning that the executables have no way to share any of their memory. This has advantages, because it is impossible for any program to damage the execution of any of the other programs running on the system. However, the programs have no way to exchange any information except through the operating system (or by reading files stored on the file system). Multi-process computing is similar to multi-tasking computing, as the terms task and process are often used interchangeably, although some operating systems make a distinction between the two.

The present invention may be a system, a method, and/or a computer program product at any possible technical detail level of integration. The computer program product may include a computer readable storage medium (or media) having computer readable program instructions thereon for causing a processor to carry out aspects of the present invention. The computer readable storage medium can be a tangible device that can retain and store instructions for use by an instruction execution device.

The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network 908, for example, the Internet, a local area network, a wide area network and/or a wireless network. The network 908 may comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions. These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or that carry out combinations of special purpose hardware and computer instructions.

Although specific embodiments of the present invention have been described, it will be understood by those of skill in the art that there are other embodiments that are equivalent to the described embodiments. Accordingly, it is to be understood that the invention is not to be limited by the specific illustrated embodiments, but only by the scope of the appended claims.

What is claimed is:

1. A system for organizing routing and delivery of a plurality of items using a depot electronic device and a delivery driver electronic device associated with a delivery driver, comprising:
a server;
the server in communication with the depot electronic device and the delivery driver electronic device, to perform a method comprising:
sending from the server to the depot electronic device a request for sorting of a plurality of items;
determining, at the server, an initial delivery route for each item of the plurality of the items;
sending, from the server to the depot electronic device and to the delivery driver electronic device, information about an initial delivery route assigned to a selected item of the plurality of items;
sorting, using a scanner associated with the depot device, the selected item of the plurality of items into a bin associated with the initial delivery route assigned to the selected item of the plurality of items;
determining, at the delivery drive electronic device, a location associated with the delivery driver electronic device;
receiving from the delivery driver electronic device, at the server and at the depot electronic device, a notification, when a location of the delivery driver electronic device is within a certain distance of the depot;
authenticating an identity of the delivery driver electronic device, once the delivery driver has arrived at a designated location proximate the depot electronic device;
scanning, using the delivery driver electronic device, the bin associated with the initial delivery route and each item of the plurality of items located in the bin, as each item of the plurality of items is transferred to a vehicle associated with the delivery driver electronic device; and
communicating, from the delivery driver electronic device to the server and to the depot device, that the transfer of items from the bin has been accomplished.

2. The system of claim 1, wherein the delivery driver electronic device includes a satellite navigation system.

3. The device of claim 1, wherein the delivery driver electronic device includes a sensor or scanner.

4. The device of claim 1, wherein the delivery driver electronic device comprises a mobile phone.

5. The device of claim 1, wherein the depot electronic device includes a sensor or scanner.

6. The device of claim 1, wherein the authentication step is performed by one of two-factor authentication, biometric authentication, geolocation information, passwords, or passcodes.

7. A method for organizing routing and delivery of a plurality of items using a depot electronic device and a delivery driver electronic device associated with a delivery driver, including a server in communication with the depot electronic device and the delivery driver electronic device, the method comprising the steps of:
sending from the server to the depot electronic device a request for sorting of a plurality of items;
determining, at the server, an initial delivery route for each item of the plurality of the items;
sending, from the server to the depot electronic device and to the delivery driver electronic device, information about an initial delivery route assigned to a selected item of the plurality of items;
sorting, using a scanner associated with the depot device, the selected item of the plurality of items into a bin associated with the initial delivery route assigned to the selected item of the plurality of items;
determining, at the delivery drive electronic device, a location associated with the delivery driver electronic device;
receiving from the delivery driver electronic device, at the server and at the depot electronic device, a notification, when a location of the delivery driver electronic device is within a certain distance of the depot;
authenticating an identity of the delivery driver electronic device, once the delivery driver has arrived at a designated location proximate the depot electronic device;
scanning, using the delivery driver electronic device, the bin associated with the initial delivery route and each item of the plurality of items located in the bin, as each item of the plurality of items is transferred to a vehicle associated with the delivery driver electronic device; and
communicating, from the delivery driver electronic device to the server and to the depot device, that the transfer of items from the bin has been accomplished.

8. The method of claim 7, wherein the delivery driver electronic device includes a satellite navigation system.

9. The method of claim 7, wherein the delivery driver electronic device includes a sensor or scanner.

10. The method of claim 7, wherein the delivery driver electronic device comprises a mobile phone.

11. The method of claim 7, wherein the depot electronic device includes a sensor or scanner.

12. The method of claim 7, wherein the authentication step is performed by one of two-factor authentication, biometric authentication, geolocation information, passwords, or passcodes.

13. A computer program product for organizing routing and delivery of a plurality of items using a depot electronic device and a delivery driver electronic device associated with a delivery driver, including a server in communication with the depot electronic device and the delivery driver electronic device, the computer program product comprising a non-transitory computer readable storage having program instructions embodied therewith, the program instructions executable by a computer, to cause the computer to perform a method comprising:
sending from the server to the depot electronic device a request for sorting of a plurality of items;
determining, at the server, an initial delivery route for each item of the plurality of the items;
sending, from the server to the depot electronic device and to the delivery driver electronic device, information about an initial delivery route assigned to a selected item of the plurality of items;
sorting, using a scanner associated with the depot device, the selected item of the plurality of items into a bin associated with the initial delivery route assigned to the selected item of the plurality of items;
determining, at the delivery drive electronic device, a location associated with the delivery driver electronic device;
receiving from the delivery driver electronic device, at the server and at the depot electronic device, a notification, when a location of the delivery driver electronic device is within a certain distance of the depot;
authenticating an identity of the delivery driver electronic device, once the delivery driver has arrived at a designated location proximate the depot electronic device;
scanning, using the delivery driver electronic device, the bin associated with the initial delivery route and each item of the plurality of items located in the bin, as each item of the plurality of items is transferred to a vehicle associated with the delivery driver electronic device; and
communicating, from the delivery driver electronic device to the server and to the depot device, that the transfer of items from the bin has been accomplished.

14. The computer program product of claim 13, wherein the delivery driver electronic device includes a satellite navigation system.

15. The computer program product of claim 13, wherein the delivery driver electronic device includes a sensor or scanner.

16. The computer program product of claim 13, wherein the delivery driver electronic device comprises a mobile phone.

17. The computer program product of claim 13, wherein the depot electronic device includes a sensor or scanner.

18. The computer program product of claim 13, wherein the authentication step is performed by one of two-factor authentication, biometric authentication, geolocation information, passwords, or passcodes.
